(19) United States
(12) Patent Application Publication
(10) Pub. No.: US 2002/0174345 A1
(43) Pub. Date: Nov. 21, 2002

(54) Remote authenticating biometric apparatus and method for networks and the like

(76) Inventor: Pankaj B. Patel, Nashua, NH (US)

Correspondence Address: PANKAJ B. PATEL, 1900 N. NEBRASKA AVE., TAMPA, FL, 33602, US

(21) Appl. No.: 09/859,608

(22) Filed: May 17, 2001

(51) Int. Cl. H04K 1/00

(52) U.S. Cl. 713/186

(57) ABSTRACT

A secured biometric apparatus and method for authenticating only authorized users into secured networks where sensitive information is located and stored. The method having the steps of sending a random number from a remote site to a local site of a user, measuring a first biometric parameter from the user with a biometric reader, comparing the first biometric parameter with a previously stored second biometric parameter, operating on the random number with a math table to create a first cryptogram when a positive match occurs between the first and second biometric parameter, sending the first cryptogram from the local site to the remote site for comparison with an internally generated cryptogram.

### BACKGROUND

1. Field of the Invention

This invention, in general, is related to the field of secured electronic transactions with the intent of preventing unauthorized access into sensitive areas. More specifically, this invention relates to a method for securely and electronically verifying a person's true identity at a remote site utilizing fingerprint reading devices and unique mathematical techniques.

2. Description of the Prior Art

Today, security issues are a high priority as it pertains to electronic transactions. Consumers and Businesses need confidence in a system that will allow them access into their sensitive accounts without fear of computer hackers gaining access. Government, banks, and others sensitive industries all use encryption techniques when transferring electronic information over networks. One of the common denominators behind these transactions is the use of passwords and usernames. Typically, in order for a person or user to enter or gain access into a secured site, he/she must remember and enter a user name and password prior to logging into a secured site. The problem with this method is that if someone gains access to your user name and password, than they can gain access to the secure site and possibly do extensive damage. Other, secure methods include using access ATM cards, smart cards, proximity cards and the like in conjunction with passwords and PIN numbers. Unfortunately, the problem of forgetting passwords and PIN numbers still exists in conjunction with someone stealing your card and password and gaining access. A possible means of eliminating passwords, usernames, ATM cards and the like, is the use of Biometrics, because with biometrics, you never forget yourself.

Another problem that exist and is growing steadily, is the number of sites that use passwords. A user now must remember multiple passwords for multiple sites in order to gain access. Some software applications are made to relieve this problem by storing all of a user's passwords into a single folder and automatically entering a person's password when logged onto that specific site. This technique is convenient, however, in a sense, this technique puts all of the users passwords in one location and could be devastating if compromised. If a hacker gained access into this password storage site, they could easily gain access to all of your sensitive sites. Other techniques, by other inventors, that can make an electronic transaction over a network more secure, are shown below.

In the patent of WO108055A1: SECURE TRANSACTION AND TERMINAL THEREFOR, “A method and apparatus are disclosed for the positive identification of an individual of use for the secure purchasing of goods or services over a visual medium such as television, the Internet and EFTPOS systems. The apparatus is a point-of-sale terminal (6) which includes a keyboard (7), a screen (8), a fingerprint reader (9), a smart card reader assembly (10) and a print head assembly incorporated within the card reader assembly (10). The operating software of the terminal (6) includes code to decrypt encrypted information read from the smart card (4). An individual wishing to undertake a secure financial transaction first obtains a smart card (4) which incorporates encrypted biometric data and financial data of that individual. At the point of intended purchase, the card (4) is placed in the reader assembly (10) of the terminal (6). The account details and encrypted biometric data are read by the terminal (6). The appropriate fingerprint of the individual is then taken at the fingerprint reader (9) of the terminal (6) from which the encryption key is determined. The encrypted fingerprint data read from the card (4) is then decrypted using the encryption key just determined and the thus-decoded fingerprint data from the card (4) is compared with the fingerprint data obtained at the terminal (6). If the thus-read fingerprint data is identical with that decoded from the card (4), identification is deemed positive and the financial transaction proceeds.”

Another method in patent WO042577A1: METHOD AND APPARATUS FOR SECURELY TRANSMITTING AND AUTHENTICATING BIOMETRIC DATA OVER A NETWORK “A method and apparatus for collecting and securely transmitting biometric data over a network contains a sensor, preferably a camera, for collecting biometric data and code generating hardware and software. The camera data is digitized and a unique code which is a function of the digitized camera data, a secret key and a transaction token is attached to the digital file. The code may identify the sensor which acquired the biometric information, a time at which the biometric information was acquired, or a time interval during which the data is considered to be valid, and a unique transaction code. The data and code are transmitted over a network to a server which authenticates that the data has not been altered by recomputing the code using its own knowledge of the secret key and transaction token needed to generate the code. If the data is authentic the server then computes a biometric template using the data. This biometric template is then compared to a previously defined biometric template to identify the user and give the user access to a secured resource. The system can be used for online banking and Internet commerce transactions.

Still another method includes U.S. Pat. No. 6,091,835: wherein, a Method and system for transcribing electronic affirmations “The invention presents a method and system for recording a detailed record or “transcript” of the acts, events and forensic circumstances related to a party's affirmation of an electronic document, transaction or event. The transcript is recorded in a data object made secure through the use of encryption and a checksum. The system directs a ceremony whereby the pat affirming the document, transaction or event is required to undertake a series of steps in order to successfully complete the affirmation and have the affirmation recorded; thus participation in the ceremony must take place before an affirmation will be accepted. The steps of the controlled procedure serve to gather evidence to confirm specifics such as that the affirming party: i) is in fact the identified party; ii) understands that by entering affirming data, e.g. a password, key, biometric sample or other affirming data he or she is thereby affirming or becoming legally accountable for the undertakings of the document, transaction or event triggered by computer interaction; iii) has adequately reviewed the document, transaction or statement to be affirmed (where a client application presents such a document transaction or statement to the system of the present invention); and iv) understands the undertaking of an event or the provisions within the document, transaction or statement and the consequences of affirming it. The system of the present invention is flexible and can be configured to accept all types of biometric, infometric and cryptographic signatures or affirming acts, such as those created by passwords, secret cryptographic keys, unique secret numbers, biometric recordings such as handwritten signatures or other biometric information, or multi-media recordings of affirming statements. It also permits the affirmation procedure to be tailored to the specifics of a client application through the use of an authentication policy component.”

In Patent WO004476A1: A PHONE HAVING ACCESS TO THE INTERNET FOR THE PURPOSES OF TRANSACTING E-MAIL, E-COMMERCE, AND E-BUSINESS, AND FOR COMMUNICATING VOICE AND DATA “The present invention relates to a public, private, or cellular phone with access to the Internet for the purposes of transacting e-mail, e-commerce, and e-business and for communicating voice and data. In addition the present invention relates to a universal advertising and payment system and method for networking, monitoring and effectuating e-mail, e-commerce, and e-business and controlling vending equipment and applications. The system can effectuate electronic commerce and interactive advertising at the point of sale in this instance at a public, private or cellular phone. Vending equipment includes copiers, phones (public, private, cellular), facsimile machines, printers, data-ports, laptop print stations, notebook computers, palmtop computers (PALM PILOT), microfiche devices, projectors, scanners, cameras, modems, communication access, personal data assistants (PDA's), pagers, and other vending machines, personal computers (PC), PC terminals (NET PC), and network computers (NC). Vending equipment can be networked to each other through a first network, programmable and accessible by a PC, server, point of sale (POS) system, property or management information system (PMS/MIS), and networked to a second network. The first network and second network can be the same network. Complete control of a vending machine's functionality including usage, control, diagnostics, inventory, and marketing data capture can be effectuated locally or by remote connection to the network. Remote connection to the network includes Internet type connections, telecommunication (telephone, ISDN, ADSL), VSAT satellite, and other wire and wireless transmission. The present invention allows a user to obtain authorization for use, pay for products and services, and configure the vending equipment with a smart card, or magnetic card (card). Magnetic cards include phone, smart card, credit card, debit card, pre-paid, automated teller machine (ATM) or other bank or private issued card. Users can also use a hotel room key/card or other insertion type-identifying device. Additionally, biometric identification such as handwriting, voice, finger, hand, or eye (iris scan) can be utilized to control the system.”

To conclude, an apparatus and/or method needs to be developed that will positively identify or authenticate a person electronically prior to entering a secured site. While some of the prior art may contain similar intentions of securing a network using common components relating to the present invention, none of them teach, suggest or include all of the advantages, methods and unique mathematical features of the present invention.

### SUMMARY

The present invention is directed towards an apparatus and method for verifying authorized users into secured networks where sensitive information is located and stored. The invention primarily utilizes random numbers, encryption, triple DATA ENCRYPTION SYSTEMS (DES) cryptograms, biometrics and other mathematical techniques.

In the basic steps for this invention, a random number is sent to a biometric reader, the random number initiates the biometric interface to activate thereby signaling the user to place his/her finger onto the biometric reader. The fingerprint is read, encrypted and then compared with the encrypted fingerprint previously stored on the biometric reader. If a positive match occurs, the random number is allowed to proceed to a mathematical table to generate an 8 byte cryptogram. This 8 byte cryptogram is then sent to the source that sent the random number and compared with an internal 8 byte cryptogram generated at the source. Note, the source that sent the random number initially creates an 8-byte cryptogram using the same random number and mathematical table as in the fingerprint reader. Thus, if a positive match occurs at the source, the person is allowed access to the site. It should be further noted that only random numbers and 8 byte cryptograms are sent over the network. This strategy prevents hackers from using probes to steal usernames, passwords and the like between computers.

For other remote transactions that take place away from the user's home or registered biometric ID box, the user at a public pay-phone, dials the phone company/server number, the screen or voice message instructs the user on the public payphone to enter his/her billing phone number. The user then enters the “Billing phone number” which now becomes his/her “Caller ID”. The phone company/server extracts the encrypted fingerprint data stored at the “Billing phone number” and connects this encrypted fingerprint data with a unique and random mathematical table. The unique mathematical table combined with the encrypted fingerprint data is then sent to the pay telephone and temporarily installed at that location. Note, the pay telephone device is first authenticated and secured prior to sending the encrypted fingerprint data. The user is then instructed to place his/her finger onto the fingerprint reader for verification. If a correct match occurs at the pay phone, the mathematical table will then generate an 8-byte cryptogram. The 8-byte cryptogram is then sent back to the phone company/server for verification (this method is based upon triple DES and other similar encryption technologies such as RSA, DSA, Diffie-Hellman, triple DES, RC2, RC4, with the understanding that fixture methods are integratable). If the 8-byte cryptogram matches at the telephone company's site, user access is allowed. The beautiful part about combining the unique and random mathematical table with the encrypted fingerprint data is that it is almost impossible to decrypt since the data is not only encrypted, but it is random as well. Further note, once the encrypted fingerprint data has been used at the pay telephone, it is erased along with the mathematical table. Note, the mathematical table is erased and/or changed for every usage.

Accordingly, it is a general object of this invention to allow only authorized persons into a secured site.

Another object of this invention is to provide a secured means of access into sensitive sites wherein only random numbers and triple DES cryptograms are sent across the network system during the access procedure.

Another object of this invention is to provide a secured means of access into sensitive sites using random numbers generated from the secured site.

Another object of this invention is to provide a unique mathematical table to transform a random number into an 8-byte cryptogram at both the secured site and at the user's site/location.

Still another object of this invention is to provide a biometric reading apparatus working in conjunction or in series with the generation of random numbers and 8-byte cryptograms.

Still another object of this invention is to provide a random number generator at the user's site to generate random numbers when a biometric match does not occur and then operate on this new random number generating a new cryptogram to be sent to the phone company/server's site for a false verification.

Still yet a further object of this invention is to provide at the users end a biometric image stored in an encrypted form used for matching.

A further object of this invention is to combine an encrypted fingerprint with a unique and random mathematical table prior to sending the data over a telephone line or network.

Still yet a further object of this invention is to erase the encrypted fingerprint data and mathematical table at a pay telephone site once the encrypted fingerprint data has been compared and used.

Another object of this invention is to provide a method in which the finger print image is never sent out from the remote pay telephone or the registered biometric ID box.

Still another object of this invention is to provide every fingerprint unit reading device with a unique math table/operator to operate on random numbers during authentication.

Still yet another object of this invention is to provide an encrypted biometric image/parameter or image stored locally for quick and easy one-to-one matches or at least one-to-few.

Still a further object of this invention is to provide a math table/operator that is installed onto the fingerprint reader in multiple parts during the initial registration process forming a triple DES cryptogram.

Other objects and a fuller understanding of the invention will become apparent from reading the following detailed Description of a preferred embodiment in conjunction with the accompanying drawings.

### BRIEF DESCRIPTION OF THE DRAWINGS

This invention, together with other objects, features, aspects and advantages thereof, will be more clearly understood from the following description, considered in conjunction with the accompanying drawings.

Ten sheets of drawings are furnished, sheet one contains FIG. 1, sheet two contains FIG. 2, sheet three contains FIG. 3, sheet four contains FIG. 4, sheet five contains FIG. 5, sheet six contains FIG. 6, sheet seven contains FIG. 7, sheet eight contains FIG. 8, sheet nine contains FIG. 9, and sheet ten contains FIG. 10.

FIG. 1 shows a block flow diagram with the basic steps for allowing an authorized user to gain access into a secured site.

FIG. 2 shows a block flow diagram with the steps of storing a biometric parameter such as a fingerprint into the biometric reader.

FIG. 3 shows a block flow diagram showing some basic steps for registering with a remote site.

FIG. 4 shows a block flow diagram of a secured transaction from a remote site using a public pay telephone.

FIG. 5 shows an orthographic view of a typical setup at a home telephone having the biometric reader inline with the telephone line

FIG. 6 shows an orthographic view of a typical setup at a home telephone having the biometric reader built into the telephone.

FIG. 7 shows an orthographic view of a typical setup at a personal computer having the biometric reader inline with the telephone line or affixed to at least one communication port in the computer.

FIG. 8 shows a block flow diagram for registering a new user using various steps to assure authentication, to store the new user's fingerprint, to install a new math table onto the fingerprint unit, and to test the enrollment process.

FIG. 9 shows a front block diagram describing a web based fingerprint authentication system with descriptions of various technologies that can be used.

FIG. 10 shows a front block diagram describing a phone based fingerprint authentication system with descriptions of various technologies that can be used.

List of Elements

1. FINGER PRINT READING APPARATUS

2. STEP WHEREIN A RANDOM NUMBER IS RECEIVED BY FINGEPRINT ID BOX

3. STEP WHEREIN A USER'S FINGERPRINT IS READ, ENCRYPTED AND COMPARED WITH A PRE-ENCRYPTED FINGPERPRINT OF THE AUTHORIZED USER.

4. STEP WHEREIN AN ALGORITHM OR MATH TABLE TAKES THE RANDOM NUMBER OF ELEMENT 2 AND GENERATES AN 8 BYTE CRYPTOGRAM.

5. STEP WHEREIN THE 8 BYTE CRYPTOGRAMS IS SENT TO PHONE COMPANY/SERVER/SERVER.

6. STEP WHEREIN A RANDOM NUMBER IS CREATED AT THE PHONE COMPANY/SERVER/SERVER IDENTICAL TO THE RANDOM NUMBER OF ELEMENT NUMBER 2.

7. STEP WHEREIN AN IDENTICAL ALGORITHM OR MATH TABLE AS IN ELEMENT NUMBER 4 TAKES THE RANDOM NUMBER OF ELEMENT 2 AND 6 AND GENERATES AN 8 BYTE CRYPTOGRAM.

8. STEP WHEREIN THE 8 BYTE CRYPTOGRAM IS STORED AT THE PHONE COMPANY/SERVER/SERVERAND AWAITS COMPARISON WITH THE 8 BYTE CRYPTOGRAM OF STEP 5.

9. STEP WHEREIN THE 8 BYTE CRYPTOGRAM OF STEP 5 AND STEP 8 ARE COMPARED FOR MATCHING AT THE PHONE COMPANIES SITE THEREBY DETERMINING WETHER THE USER IS GRANTED OR DENIED ACCESS.

10. STEP WHEREIN FINGERPRINT IS READ AND MINUTIA POINTS ARE OBTAINED (400 DOTS PER INCH EXAMPLE)

11. STEP WHEREIN FINGERPRINT IS ENCRYPTED

12. STEP WHEREIN ENCRYTED FINGERPRINT IS STORED LOCALLY AT THE FINGERPRINT READER.

13. STEP WHEREIN USER CALLS PHONE COMPANY/SERVER/SERVER

14. STEP WHEREIN USER REGISTER HIS/HER IDENTITY BY ENTERING BILLING TELEPHONE NUMBER OR THE LIKE.

15. STEP WHEREIN PHONE COMPANY/SERVER/SERVER SENDS UNIQUE ALGORITHM OR MATH TABLE TO REMOTE PHONE STATION

16. STEP WHEREIN MATH TABLE IS STORED LOCALLY ONTO BIOMETRIC ID OR FINGEPRINT READER

17. STEP WHEREIN USER ENTERS HIS/HER BIOMETRIC INFORMATION ONTO FINGERPRINT READER

18. STEP WHEREIN FINGERPRINT IS SENT TO PHONE COMPANY/SERVER/SERVER AND STORED ONTO LOCAL FINGERPRINT READER. Note anytime the fingerprint data is sent, the fingerprint data is always in an encrypted format.

19. STEP WHEREIN CUSTOMER ENTERS PREREGISTERED PHONE FROM REMOTE LOCATION, NORMALLY A PAY TELEPHONE. NOTE, THIS COULD BE A REMOTE PERSONAL COMPUTER TERMINAL.

20. MOUSE

21. STEP WHEREIN PHONE COMPANY/SERVER/SERVER SENDS ENCRYPTED FINGERPRINT DATA AND UNIQUE MATH TABLE TO PAY TELEPHONE AND IS STORED AT PAY TELEPHONE.

22. STEP WHEREIN PHONE COMPANY/SERVER/SERVER SENDS RANDOM NUMBER TO PAY TELEPHONE TO INITIATE OR SIGNAL THE USER TO ENTER HIS/HER FINGERPRINT.

23. STEP WHEREIN USER/CUSTOMER ENTERS HIS/HER FINGERPRINT ONTO FINGERPRINT READER. THE FINGERPRINT THAT WAS JUST READ IS THEN COMPARED WITH THE FINGERPRINT THAT WAS

24. STEP WHEREIN A RANDOM NUMBER IS TRANSFORMED BY UNIQUE MATH TABLE OF ELEMENT 21 TO CREATE AN 8 BYTE CRYPTOGRAM. NOTE, THIS STEP ONLY TAKES PLACE IF A POSITIVE MATCH HAS OCCURRED IN ELEMENT 23.

25. STEP WHEREIN THE 8 BYTE CRYPTOGRAM IS SENT TO THE PHONE COMPANY/SERVER/SERVER FOR COMPARISON AND IF A MATCH OCCURS BETWEEN THE 8 BYTE CRYPTOGRAMS, ACCESS IS GIVEN TO THE USER.

26. TELEPHONE LINE

27. PHONE JACK

28. FINGERPRINT READER

29. FINGERPRINT READER HOUSING

30. TELEPHONE

31. PERSONAL COMPUTER

32. REGISTRATION STEP WHEREIN CUSTOMER CALLS PHONE COMPANY/SERVER

33. REGISTRATION STEP WHEREIN FINGERPRINT UNIT IS AUTHENTICATED

34. REGISTRATION STEP WHEREIN PHONE COMPANY/SERVER SENDS FIRST ENROLLMENT CODE (SINGLE DES) TO FINGERPRINT UNIT

35. REGISTRATION STEP WHEREIN USER PLACES HIS/HER FINGEPRINT ONTO FINGERPRINT READER

36. REGISTRATION STEP WHEREIN FINGERPRINT IS ENCRYPTED STORED TEMPORARILY

37. REGISTRATION STEP WHEREIN PHONE COMPANY/SERVER SENDS SECOND ENROLLMENT CODE (SINGLE DES) TO FINGERPRINT READER ALONG WITH A RANDOM NUMBER FOR TESTING.

38. REGISTRATION STEP WHEREIN THE FIRST AND SECOND ENROLLMENT CODE ARE COMBINED TO FORM THE COMPLETE MATH TABLE FOR TRIPLE DES.

39. REGISTRATION STEP WHEREIN USER PLACES HIS/HER FINGEPRINT ONTO FINGERPRINT READER

40. REGISTRATION STEP WHEREIN FINGERPRINTS ARE COMPARED ON FINGERPRINT READER FOR A POSITIVE MATCH

41. REGISTRATION STEP WHEREIN IF A POSITIVE MATCH OCCURS, THE RANDOM NUMBER IS THEN OPERATED ON BY THE COMPLETE MATH TABLE OF ELEMENT 38 TO FORM A TRIPLE DES CRYPTOGRAM

42. REGISTRATION STEP WHEREIN THE TRIPLE DES CRYPTOGRAM OF ELEMENT 41 IS THEN SENT TO PHONE COMPANY/SERVER

43. REGISTRATION STEP WHEREIN THE TRIPLE DES OF ELEMENT 41 IS COMPARED WITH AN INTERNALLY GENERATED TRIPLE DES CRYPTOGRAM FROM THE PHONE COMPANY/SERVER'S SITE

44. REMOTE SERVER

45. WORLD WIDE WEB/INTERNET

46. ENCRYPTED XML PACKET FLOW

47. PBX/INTERNET PHONE/CELL PHONE

48. FINGERPRINT UNIT CONNECTION TO COMPUTER USING VARIOUS SYSTEMS SUCH AS RS232, RS485, RS422, USB, PCMCIA, PCI, INFRARED, BLUETOOTH, WIRELESS, ANY CUSTOM AS WELL AS INDUSTRY STANDARD INTERFACES AND FUTURE SYSTEMS.

49. COMPUTER CONNECTION TO WORLD WIDE WEB USING VARIOUS SYSTEMS SUCH AS TELEPHONE LINES, CELL PHONES, ANY CUSTOM INTRANET, AND INTERENT INTERFACES, AS WELL AS ANY OTHER FUTURE SYSTEMS.

50. PHONE CONNECTION TO PUBLIC COMMUNICATION NETWORK USING MODEM INTERFACE TO INTERNET PHONE, CELL PHONE INTERFACE, AND ANY OTHER CURRENT OR FUTURE MEANS OF CONNECTION

51. PUBLIC COMMUNICATION NETWORK CONNECTION TO REMOTER SERVER USING TELEPHONE LIES, PUBLIC TELEPHONE NETWORK, CELL PHONE, ANDY CUSTOM OR STANDARD INTERFACE AS WELL AS ANY FUTURE OR PAST CONNECTION MEANS.

### DESCRIPTION OF THE PREFERRED EMBODIMENTS

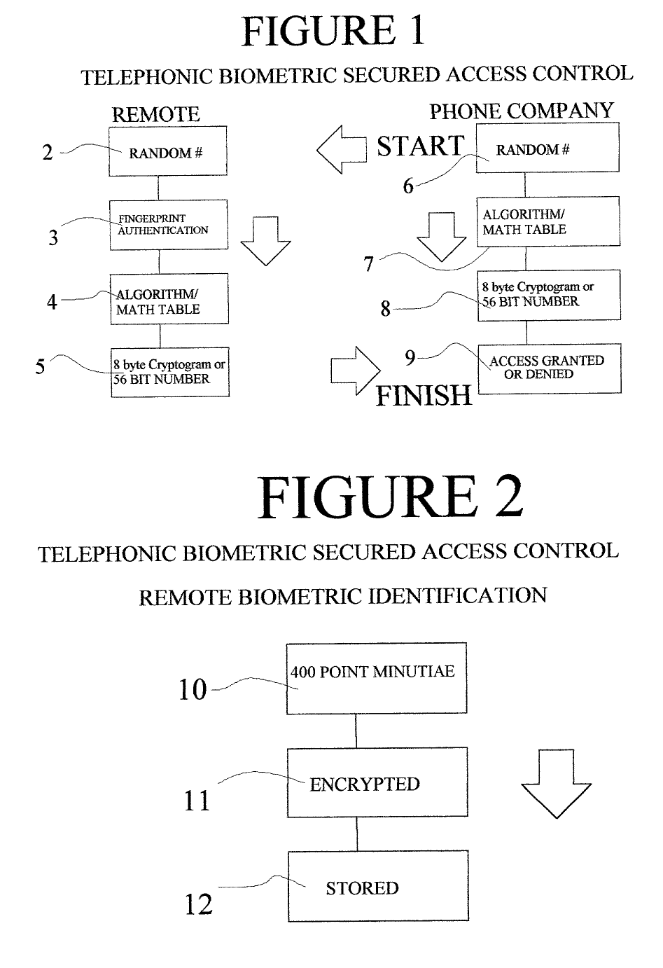

In FIG. 1, the primary steps for authenticating a verified user are shown in the block flow diagram, starting at element 6. A random number is generated from the phone company/server and is sent down two paths. The first path is the remote path beginning at element 2. In the remote path, the random number starts the fingerprint reader of element 3 whereby the customer is signaled from the reader to place his/her finger onto the reader for scanning. Next, the fingerprint is encrypted and compared with a previously stored encrypted fingerprint on the fingerprint ID unit. If a match occurs, the random number is sent into the math table of element 4 to create a cryptogram in element 5.

Identically to the first path with the exception of the fingerprint-reading step, the same random number starting at element 6 is sent to math table of element 7. Note, math table in element 7 and element 4 are identical and unique to the customer. This math table of element 7 takes the random number and generates a gram in element 8. The elements of 6, 7, 8 and 9 are located at the phone company/server's site. After the cryptograms of element 8 and element 5 are completed, they are compared in element 9. If a match occurs, the customer is allowed access, if a match does not occur, access is denied and another trial is given to the customer.

In FIG. 2, a simple block flow diagram is shown whereby the fingerprint is read to create a 400-point image of the fingerprint element 10. Next, in element 11, the fingerprint is encrypted and stored (element 12) locally on the fingerprint ID box. The biometric data is stored as encrypted minutiae points, which cannot be reversed, engineered. Further note, the minutiae points are the unique characteristics of the acquired biometrc data which does not represent the actual fingerprint image, audio data, facial image or any of the like.

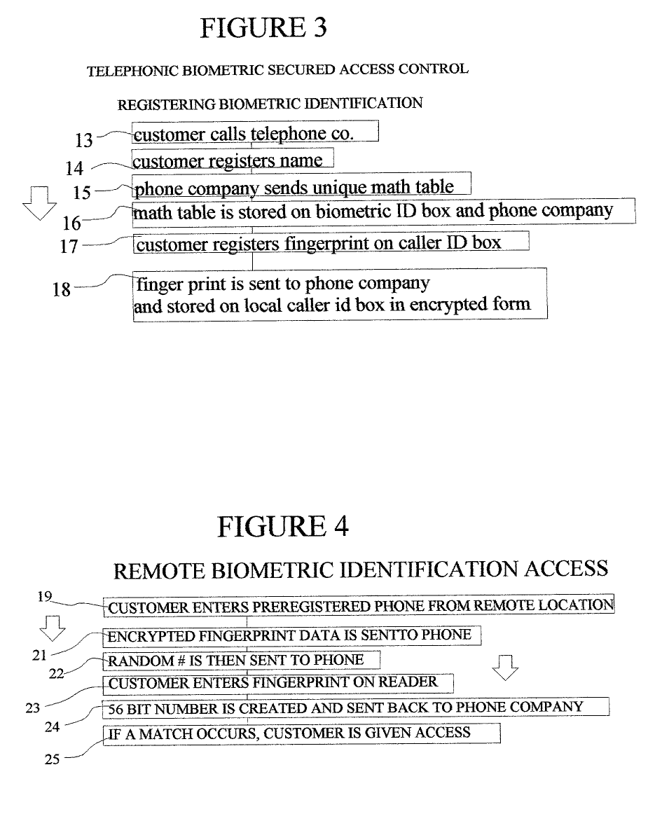

In FIG. 3, a basic registration process is shown whereby the necessary or key steps are shown in block flow form. In element 13, the customer calls the telephone company/server whereby the caller id asks the customer to confirm his/her identity. If necessary, the customer enters his/her information using the keypad of the telephone, as is element 14. After a name has been confirmed, a unique math table is sent to the fingerprint ID box and stored as in elements 15 and 16. Once a unique math table has been stored onto the fingerprint reading ID box, the customer is then asked to register a fingerprint onto the reader. The fingerprint is read from the reader and encrypted and stored onto the fingerprint ID box. A copy of the encrypted fingerprint is then sent to the phone company/server for storage as in element 18. Storing the fingerprint locally onto the caller ID box allows for a one to one match, thereby greatly increasing the speed in which the fingerprint is read and compared for verification. Note, the specific sequence of registering can be altered without effecting the overall operation of the registration process.

FIG. 4 refers a block flow diagram whereby a customer can perform a secure transaction from a remote location such as a pay telephone. The first element 19, the customer calls a number for the telephone company/server and enters his/her home telephone number or any number that is registered to him. The phone company/server recognizes this number along with the associated unique math table and forwards this table back to the pay telephone, as represented by element 20. The math table is then stored locally at the pay telephone and awaits the encrypted fingerprint data previously registered from the customer as in element 21. Finally, after the math table and encrypted fingerprint data is stored locally at the pay telephone, element 22, a random number is sent from the phone company/server to initiate the secured authentication.

Once the random number is received by the pay telephone, the fingerprint reader begins to flash or beep signaling to the customer to place his/her finger onto the reader for verification. The fingerprint is read, encrypted and compared with the stored fingerprint. If a match occurs, the random number is allowed processing by the math table thereby creating a cryptogram. If there is no match during the fingerprint reading process, an incorrect cryptogram is generated and sent to the phone company/server/server whereby access is denied. Note, the specific example of using 56 byte numbers can easily be replaced with more secure 128 byte numbers or less secure numbers.

In element 24, the cryptogram is sent back to the phone company/server to be compared with the cryptogram created internally at the phone company/server location. Note, the phone company/server uses the same math table and the same random number to generate this cryptogram. In element 25, if a match occurs, the customer is granted access and the biometric verification is complete. If the fingerprint did not match the encrypted fingerprint, a different cryptogram will be generated and sent to the phone company/server whereby a non-match occurs and access is denied. Note again, the specific sequence of registering can be altered without effecting the overall operation of the registration process, however, the above method is preferred to optimize speed of the transactions.

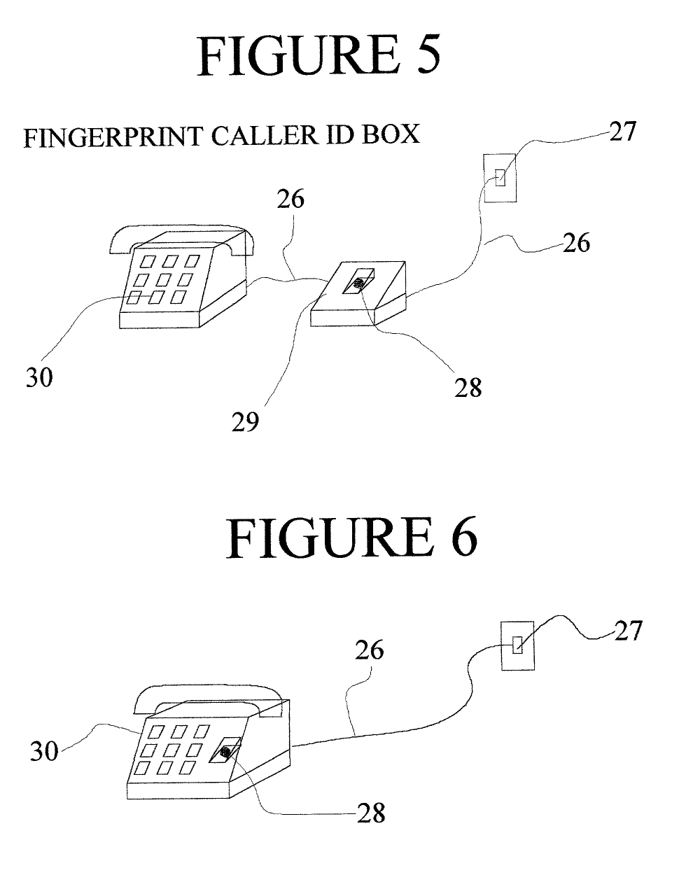

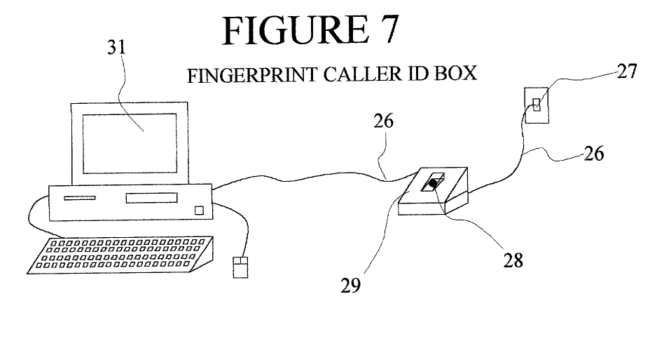

Referring now to FIGS. 5, and 6, orthographic views of a typical telephone 30 with the fingerprint ID box 29 affixed in series with the telephone line 26, FIG. 5. The telephone line is then connected to a telephone jack 27 shown here on the wall. Future models will have the fingerpint-reading portion 28 integrated into the housing of the telephone 30 as in FIG. 6. At home, a user simply connects the Fingerprint Authentication Unit device, which is similar to the caller ID boxes and answering machines, in series with the telephone 30 and phone jack 27. Note, these modifications or integrations can also be applied to cordless telephones, cell phones, radios, computer terminals, PCs, computer mice, laptops, and the like. FIG. 7 shows the fingerprint ID box 29 electrically connected to a personal computer 31 and phone jack 27. The interface between the fingerprint ID box 29 and the personal computer 31 can be an assortment of ports such as serial port, USB, Ethernet, or any of the like.

All inversions reported until now store the fingerprint data or biometrics data on computer hard drive or similar devices from which a hacker can extract the information. This method can compromise the system. This fingerprint authentication system (FAS) does not allow any application to be downloaded to the system. Also, our fingerprint authentication system (FAS) simply responds to the encrypted XML challenge packet and when it determines an attack is in progress, it would respond with false results even when the fingerprint authentication is successful for unknown number of times before the unit will return back to normal operation automatically thereby reducing the effect of Brute Force Method.

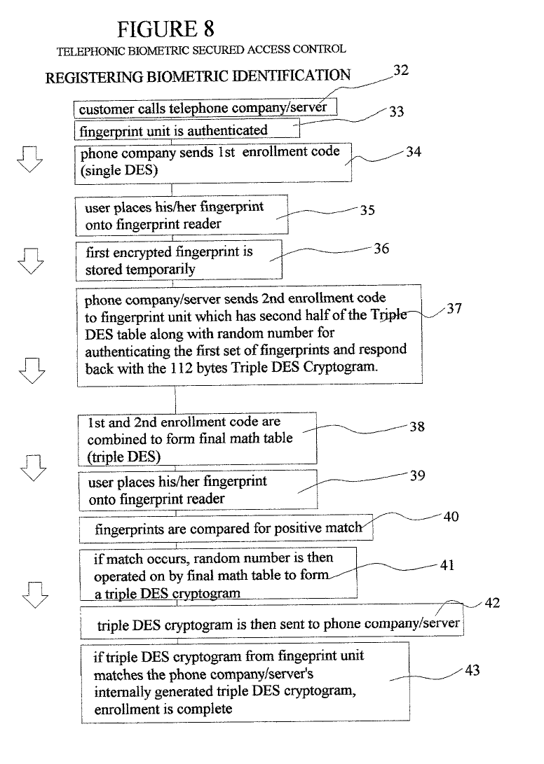

In reviewing the steps for enrollment in FIG. 8, the user first calls the phone company/server (element 32). The remote device (fingerprint reader) is authenticated (element 33) from the phone company/server's site through an encryption mechanism to obtain the ID or serial number of the fingerprint reader. Next, a 1st enrollment code is sent to the device (element 34). This 1^{st} enrollment code contains half or a portion of the math table that will be installed onto the fingerprint reading device (normally called single DES [Data encryption system]). The user is then instructed to place his/her finger onto the fingerprint reader for scanning to obtain the first fingerprint image (element 35). The first fingerprint image is then encrypted and sent back to the phone company/server, along with the fingerprint reade's ID/serial number (element 36). The phone company/server extracts and stores this encrypted fingerprint image and sends back a second verifying code (again single DES) that contains the remaining portion of the math table and a test random number as a challenge for verification (element 37). The user is then instructed to place his/her finger onto the fingerprint reader to acquire the second fingerprint image (element 39). The encrypted fingerprints are then compared for a match (element 40). If a match occurs, the first and second verifying codes are combined to form a third verifying code or complete math table (element 38) (now called triple DES). The complete math table now operates on the test random number of element 37 and creates a triple DES cryptogram (element 41) which is sent back to the phone company/server's site (element 42) which matches with the phone company/server's internally generated triple DES cryptogram to finalize the successful enrollment procedure. The procedure is finalized only if the triple DES cryptogram from the fingerprint reader's location and the triple DES from the phone company/server's location have a positive match (element 43). If no positive match occurs, then the enrollment procedure must be repeated.

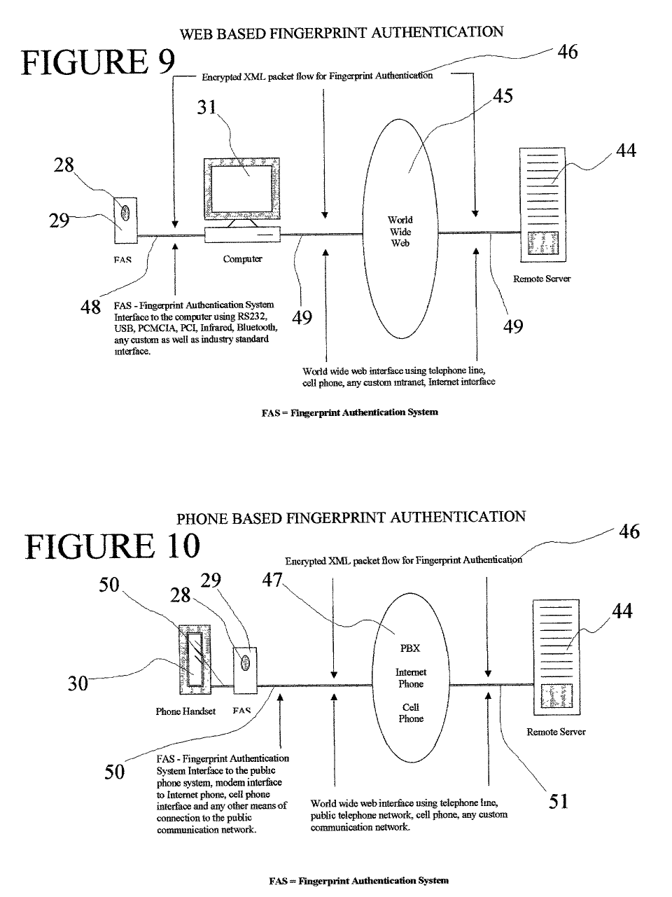

FIGS. 9 and 10 show both general diagrams for a WEB based Fingerprint Authentication and a PHONE based Fingerprint Authentication. If FIG. 9, the fingerprint reader is connected to a computer 31 via the connection (element 48) of various technologies such as RS232, USB, PCMCIA, PCI, INFRARED, BLUETOOTH, WIRELESS, as well as any custom as well as industry standard interface. The computer 31 is connected to the World Wide Web 45 and to the Remote Server 44 through connections (element 49) such as telephone lines, cell phones, any custom or standard Intranet, Internet interface. In FIG. 10, the phone based Fingerprint Authentication uses a telephone 30 connected to a fingerprint reader 29 through connection (element 50) such as phone systems, modem interfaces, internet phones, cell phones interface and any other means of connection to the public communication network. The fingerprint reader 29 is then connected to the PBX (47), Internet phone, or cell phone. It should be noted that communication lines 46 of FIGS. 9 and 10 are all encrypted XML packet flows or whatever past, present, or future secured means of information exchange or flows are available.

Since minor changes and modifications varied to fit particular operating requirements and environments will be understood by those skilled in the art, the invention is not considered limited to the specific examples chosen for purposes of illustration, and includes all changes and modifications which do not constitute a departure from the true spirit and scope of this invention as claimed in the following claims and reasonable equivalents to the claimed elements.

What is claimed is:

1. A method for authenticating a user over a network comprising the steps of:
a) sending a random number from a remote site to a local site of a user,
b) measuring a first biometric parameter from said user with a biometric reader,
c) comparing said first biometric parameter with a previously stored second biometric parameter,
d) operating on said random number with a math table to create a first cryptogram when a positive match occurs between said first and second biometric parameter,
e) sending said first cryptogram from said local site to said remote site for comparison with an internally generated cryptogram.

2. A method for authenticating a user over a network as in claim 1 further comprising the step of encrypting said first biometric parameter to form a first encrypted biometric parameter.

3. A method for authenticating a user over a network as in claim 1 further comprising the step of generating a first cryptogram from said random number if said first encrypted biometric parameter positively matches said second encrypted biometric parameter.

4. A method for authenticating a user over a network as in claim 1 further comprising the step of sending said first generated cryptogram to said remote site for comparison with a second cryptogram.

5. A method for authenticating a user over a network as in claim 4 wherein said second cryptogram is generated from a site other than from said local site.

6. A method for authenticating a user over a network as in claim 1 further comprising the step of allowing user access if said first cryptogram matches said second cryptogram.

7. A method for authenticating a user over a network comprising the steps of:
a) sending a random number from a remote site to the site of the user,
b) measuring a biometric parameter from said user with a biometric reader,
c) comparing said first encrypted biometric parameter with a second encrypted biometric parameter previously stored on said biometric reader,
d) generating a second random number when said first encrypted biometric parameter does not positively match said second encrypted biometric parameter,
e) operating on said second random number with a math table to create a first cryptogram when a positive match fails to occur between said first and second biometric parameter,
f) sending said first cryptogram from said local site to said remote site for comparison with an internally generated cryptogram.

8. A method for authenticating a user over a network as in claim 7 further comprising the step of denying user access if said first cryptogram does not match said second cryptogram.

9. A method for authenticating a user over a network as in claim 7 further comprising the step of generating a first cryptogram from said second random when said first encrypted biometric parameter does not match said second biometric parameter.
